(19) United States
(12) Patent Application Publication
(10) Pub. No.: US 2021/0232531 A1
(43) Pub. Date: Jul. 29, 2021

(54) System and Methods for Connecting Peripheral Devices to Host Computers

(71) Applicants: Swaroop Patel, Hoffman Estates, IL (US); Karthikayan Balakrishnan, Vernon Hills, IL (US)

(72) Inventors: Swaroop Patel, Hoffman Estates, IL (US); Karthikayan Balakrishnan, Vernon Hills, IL (US)

(21) Appl. No.: 17/160,119

(22) Filed: Jan. 27, 2021

Related U.S. Application Data
(60) Provisional application No. 62/966,285, filed on Jan. 27, 2020.

(51) Int. Cl. G06F 13/42

(52) U.S. Cl. CPC G06F 13/4282; G06F 3/04842; G06F 2213/0042

(57) ABSTRACT

Systems and methods for connecting peripheral devices to host computers allow for transmission of data to one of a plurality of host computers. Transmission may be wired or wireless. In a preferred embodiment, at least one peripheral connected device attached to a target peripheral device transmits data to one of a plurality of host connected devices, each of which is attached to a host computer. The peripheral connected device preferably comprises a screen for selection of one of the plurality of host connected devices for wired or wireless data transfer between the target peripheral device and a desired host computer. The desired host computer is selected from a plurality of available host computers via the peripheral connected device.

### CROSS-REFERENCE TO RELATED APPLICATIONS

The present invention claims priority to U.S. Prov. Pat. App. No. 62/966,285, titled “Systems and Methods for Wirelessly Connecting USB Devices to Host Computers,” filed Jan. 27, 2020, which is incorporated by reference herein in its entirety.

### TECHNICAL FIELD

The present invention relates to systems and methods for connecting peripheral devices to host computers. Specifically, a peripheral device transmits data to one of a plurality of host computers. Transmission may be wired or wireless. In a preferred embodiment, at least one peripheral connected device attached to a target peripheral device transmits data to one of a plurality of host connected devices, each of which is attached to a host computer. The peripheral connected device preferably comprises a screen for selection of one of the plurality of host connected devices for wired or wireless data transfer between the target peripheral device and a desired host computer. The desired host computer is selected from a plurality of available host computers via the peripheral connected device.

### BACKGROUND

Peripheral devices are often connected to host computers via wired or wireless connections. Typically, a peripheral device is simply hardwired directly to a desired host computer so that the peripheral device can send data to the host computer. In a situation where one or more peripheral device transmits data to one of a plurality of host computers, it is often the case that the host computer is used to select the desired peripheral device to communicate with, through a local network, thereby establishing a connection, or pairing, of the host computer to the peripheral device for transmitting of data between the peripheral device and the host computer.

When a peripheral device is utilized a distance from a host computer, it is often difficult for a user to have to set up a peripheral device, then go to the host computer to establish the connection between the desired host computer and the desired peripheral device, then go back to the peripheral device to use the peripheral device. For example, in a medical or dental setting, a peripheral device may include an imaging device that is used on a patient. First, the user must activate and/or set up the peripheral device, then travel to the desired host computer for receiving the imaging data to use the host computer to select the peripheral device through the local network (which is often in another room), then travel back to peripheral device to use the peripheral device thereby sending data to the host computer.

Moreover, typical peripheral devices having specific functionality generally transmit data between the peripheral device and a host computer via a wired connection. For example, in a dentist's office, an electronic X-ray sensor is often connected via a long USB cable to a host computer. When X-ray images of a patient's teeth are taken, the image data is sent via the USB cable to the host computer for display and storage of the same.

Long runs of USB cable are often difficult to use, get in the way, and often are prone to breakage. For example, an X-ray image sensor is often moved from one location to another, and is often connected to a host computer that is a distance away from the patient, oftentimes in a different room. Constant manipulation of the peripheral device can cause the cable to break at weak connection points. In addition, chairs and other rolling items can roll over the cable causing breakage of the same. A need, therefore, exists for improved connection solutions between peripheral devices and host computers. Specifically, a need exists for a wireless solution to connect peripheral devices and host computers. More specifically, a need exists for wireless solutions that eliminate the need for long cable runs to connect peripheral devices to host computers.

Moreover, long cable runs are often unsightly, especially in a professional setting. Because peripheral devices, such as X-ray image sensors, must be utilized on a patient, the cables connecting the X-ray image sensors must be exposed, where patients can see them. They must also be relatively loose so that a dental assistant can manipulate the same when in use. It is, therefore, difficult to contain these cables and make them look neat and organized. A need, therefore, exists for an improved connection solution between peripheral devices and host computers that eliminates clutter and provide a tidy appearance. Specifically, a need exists for an improved connection solution between peripheral devices and host computers that are difficult to see or notice by others.

In addition, it is often the case that peripherals must be connected to different host computers when used from one setting to another. For example, dental X-ray image sensors may be utilized by different dental assistants in different rooms. Thus, oftentimes, dental assistants must unplug the X-ray image sensors from one computer, transport them and their long cable run into a different room, and plug the same into a different host computer. The constant plugging and unplugging of peripheral equipment can be time-consuming and difficult, and also unprofessional, as users thereof must often intrude into others' workspaces to retrieve and move the peripheral devices. A need, therefore, exists for an improved connection solution, either wired or wireless, between a peripheral device and a host computer that eliminates constant plugging and unplugging of peripheral devices to host computers. Moreover, a need exists for an improved connection solution between a peripheral device and a host computer that prevents intrusion into workspace to retrieve connected peripheral device for connection to other host computers.

Also, a user of a peripheral device may desire to use a peripheral device in a setting where the USB cable is too short to connect a peripheral device to a host computer. In such a case, a user must often daisy-chain several USB cables together to achieve the desired connection. A need, therefore, exists for an improved connection solution between a peripheral device and a host computer that is not limited by distance. Moreover, a need exists for an improved connection solution between a peripheral device and a host computer that eliminates the need for additional equipment, such as longer cables, to connect to host computers.

Further, it may be desired to utilize one of a plurality of peripheral devices, each of which may be needed to be connected to one or more host computers. Oftentimes, when a user wishes to use a different peripheral device with a host computer, he or she must unplug another peripheral device and plug in the desired peripheral device. A need, therefore, exists for an improved connection solution between a plurality of peripheral devices and one or more host computers, either wired or wireless. Specifically, a need exists for an improved connection solution that allows one to easily disconnect one peripheral device and connect another peripheral device to a host computer.

Still further, it may be desired to utilize a first peripheral device in a first host computer and, at the same, utilize a second peripheral device in a second host computer. In such a situation, long USB cable runs can exacerbate the problems described above, and may cause further problems, such as increased unsightliness and entanglement of the cables together. A need, therefore, exists for an improved connection solution between a plurality of peripheral devices and a plurality of host computers, connected together at the same time.

### SUMMARY OF THE INVENTION

The present invention relates to systems and methods for connecting peripheral devices to host computers. Specifically, a peripheral device transmits data to one of a plurality of host computers. Transmission may be wired or wireless. In a preferred embodiment, at least one peripheral connected device attached to a target peripheral device transmits data to one of a plurality of host connected devices, each of which is attached to a host computer. The peripheral connected device preferably comprises a screen for selection of one of the plurality of host connected devices for wired or wireless data transfer between the target peripheral device and a desired host computer. The desired host computer is selected from a plurality of available host computers via the peripheral connected device.

To this end, in an embodiment of the present invention, a system for connecting a peripheral device to one of a plurality of host computers to transfer data therebetween is provided. The system comprises: a first peripheral device connected to a first peripheral connected device; a first host computer connected to a first host connected device; wherein the first peripheral connected device is configured to scan for available host connected devices and identify on the first peripheral connected device the available host connected devices found in the scan, and wherein the first host connected device is selectable at the first peripheral connected device, wherein selecting the first host connected device causes the first peripheral connected device to pair with the first host connected device establishing a first connection allowing data to transfer between the first peripheral device and the first host computer.

In an embodiment, the first peripheral device is connected to the first peripheral connected device via a first USB connection, the first host computer is connected to the first host connected device via a second USB connection.

In an embodiment, the first peripheral connected device and the first host connected device transfer data between the first peripheral device and the first host computer via a wired or wireless connection.

In an embodiment, the first peripheral connected device and the first host connected device transfer data between the first peripheral device and the first host computer via a wireless connection.

In an embodiment, the system further comprises: a second host computer connected to a second host connected device, wherein selecting the second host connected device causes the first peripheral connected device to pair with the second host connected device establishing a second connection allowing the data to transfer between the first peripheral device and the second host computer.

In an embodiment, the system further comprises: a second peripheral device connected to a second peripheral connected device, wherein the first host connected device and the second host connected device are selectable at the second peripheral connected device.

In an embodiment, the system further comprising: a second peripheral device connected to a second peripheral connected device, wherein the first host connected device is selectable at the second peripheral connected device.

In an embodiment, the first peripheral connected device comprises a screen, wherein the available host connected devices are displayed on the screen.

In an embodiment, the first peripheral connected device comprises a screen, wherein data generated by the first peripheral device is displayed on the screen.

In an embodiment, the first peripheral connected device comprises a storage medium, wherein data generated by the first peripheral device is stored in the storage medium of the first peripheral connected device.

In an alternate embodiment of the present invention, a method for connecting at least one peripheral device to one of a plurality of host computers to transfer data therebetween is provided. The method comprises: providing a first peripheral device connected to a first peripheral connected device; providing at least one host computer connected to a first host connected device; scanning, at the first data transmitter, for available host connected devices; identifying on the first peripheral connected device the available host connected devices found in the scan, wherein the first host connected device is selectable at the first peripheral connected device; selecting the first host connected device at the first peripheral connected device, wherein selecting the first host connected device causes the first peripheral connected device to pair with the first host connected device establishing a first connection allowing first data to transfer between the first peripheral device and the first host computer; and transferring the first data between the first peripheral connected device and the first host connected device.

In an embodiment, the first peripheral connected device and the first host connected device transfer the first data between the first peripheral device and the first host computer via a wired or a wireless connection.

In an embodiment, the first peripheral connected device and the first host connected device transfer the data between the first peripheral device and the first host computer via a wireless connection.

In an embodiment, the method further comprises the step of: providing a second host computer connected to a second host connected device; selecting the second host connected device at the first peripheral connected device, wherein selecting the second host connected device causes the first peripheral connected device to pair with the second host connected device establishing a second connection allowing second data to transfer between the first peripheral device and the second host computer; and transferring the second data between the first peripheral connected device and the second host connected device.

In an embodiment, the method further comprises the steps of: providing a screen on the first peripheral connected device; and displaying the first data from the first peripheral device on the first screen.

In an embodiment, the method further comprises the steps of: providing a screen on the first peripheral connected device; and displaying the available data receivers on the screen.

In an embodiment, the method further comprises the step of: providing a second peripheral device connected to a second peripheral connected device, wherein the first host connected device is selectable at the second peripheral connected device.

In an embodiment, the method further comprises the steps of: selecting the first host connected device at the second peripheral connected device; and receiving a message at the second peripheral connected device indicating that the first host connected device is unavailable to connect to the second peripheral connected device.

In an embodiment, the method further comprises the steps of: providing a second host computer connected to a second host connected device; selecting the second host connected device at the second peripheral connected device, wherein selecting the second host connected device causes the second data peripheral connected device to pair with the second host connected device establishing a second connection allowing second data to transfer between the second peripheral device and the second host computer; and transferring the second data between the second peripheral connected device and the second host connected device.

In an embodiment, the method further comprises the steps of: providing a first screen on the first peripheral connected device; displaying the available data receivers on the first screen; and providing a second screen on the second peripheral connected device; and displaying the available data receivers on the second screen.

In an embodiment, the step of selecting the first host connected device at the first peripheral connected device further comprises: selecting the first host connected device on the first screen of the first peripheral connected device, and further comprising the steps of: selecting the second host connected device on the second screen of the second peripheral connected device; and transferring the second data between the second peripheral connected device and the second host connected device.

In an embodiment, the method further comprises the step of: processing the first data at the first peripheral connected device prior to transferring the first data from the first peripheral connected device to the first host connected device.

In an alternate embodiment of the present invention, a method for connecting at least one peripheral device to one of a plurality of host computers to transfer data therebetween is provided. The method comprises the steps of: providing a first peripheral device connected to a first peripheral connected device, wherein the first peripheral connected device comprises a storage medium; providing at least one host computer connected to a first host connected device; scanning, at the first data transmitter, for available host connected devices; and storing first data in the storage medium of the first peripheral connected device.

In an embodiment, the method further comprises the steps of: selecting the first host connected device at the first peripheral connected device; pairing the first peripheral connected device with the first host connected device; and sending the first data from the storage medium of the first peripheral connected device to the first host connected device.

It is, therefore, an advantage and objective of the present invention to provide an improved connection solution between peripheral devices and host computers.

Specifically, it is an advantage and objective of the present invention to provide a wireless solution to connect peripheral devices and host computers.

More specifically, it is an advantage and objective of the present invention to provide wireless solutions that eliminate the need for long cable runs to connect peripheral devices to host computers.

Further, it is an advantage and objective of the present invention to provide an improved connection solution between peripheral devices and host computers that eliminate clutter and provide a tidy appearance.

Specifically, it is an advantage and objective of the present invention to provide an improved connection solution between peripheral devices and host computers that are difficult to see or notice by others.

Still further, it is an advantage and objective of the present invention to provide an improved connection solution between a peripheral device and a host computer that eliminates constant plugging and unplugging of peripheral devices to host computers.

Moreover, it is an advantage and objective of the present invention to provide an improved connection solution between a peripheral device and a host computer that prevents intrusion into workspace to retrieve connected peripheral device for connection to other host computers.

In addition, it is an advantage and objective of the present invention to provide an improved connection solution between a peripheral device and a host computer that is not limited by distance.

And, it is an advantage and objective of the present invention to provide an improved connection solution between a peripheral device and a host computer that eliminates the need for additional equipment, such as longer cables, to connect to host computers.

Moreover, it is an advantage and objective of the present invention to provide an improved connection solution between a plurality of peripheral devices and one or more host computers.

Specifically, it is an advantage and objective of the present invention to provide an improved connection solution that allows one to easily disconnect one peripheral device and connect another peripheral device to a host computer.

Further, it is an advantage and objective of the present invention to provide an improved connection solution between a plurality of peripheral devices and a plurality of host computers, connected together at the same time.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a wireless system in an embodiment of the present invention.

FIG. 2 illustrates a wireless system in an alternate embodiment of the present invention.

FIG. 3 illustrates a flow chart diagram of a wireless pairing methodology between a target USB device and a host computer in an embodiment of the present invention.

FIG. 4 illustrates a flow chart diagram of a wireless pairing methodology concerning a connection refusal in an embodiment of the present invention.

FIG. 5 illustrates a flow chart diagram of a wireless pairing methodology concerning a concurrent data transfer in an embodiment of the present invention.

### DETAILED DESCRIPTION OF THE PRESENTLY PREFERRED EMBODIMENTS

The present invention relates to systems and methods for connecting peripheral devices to host computers. Specifically, a peripheral device transmits data to one of a plurality of host computers. Transmission may be wired or wireless. In a preferred embodiment, at least one peripheral connected device attached to a target peripheral device transmits data to one of a plurality of host connected devices, each of which is attached to a host computer. The peripheral connected device preferably comprises a screen for selection of one of the plurality of host connected devices for wired or wireless data transfer between the target peripheral device and a desired host computer. The desired host computer is selected from a plurality of available host computers via the peripheral connected device.

The present invention may be wired or wireless, and may transmit data via any data transmission protocol apparent to one of ordinary skill in the art. Likewise, while the present invention details “USB data transfer” and “USB devices,” it should be readily apparent that the present invention may be implemented using any device and/or computer communication protocol and/or endpoint, or port, including USB (such as, for example, USB-C), ethernet, Lightning, IEEE 1394 (Firewire), Thunderbolt, DisplayPort, or other like communication and endpoint protocols, and the present invention should not be limited as described herein. Moreover, although the present invention describes exemplary embodiments used in medical or dental applications, the present invention should not be so limited, as the present invention may be utilized to transmit data between any one or more peripheral devices and one of a plurality of host computers.

In an exemplary embodiment of the present invention, FIG. 1 illustrates a wireless USB data transfer system 10. The system 10 comprises a target USB device 12 that may be connected via USB connection to a peripheral connected device 14 of the present invention. The target USB device 12 may be any peripheral device or apparatus that may have a functionality that is normally connected directly into a host computer's USB port. Typically, the host computer provides power and allows for data transfer between the target USB device and the host computer via a transfer medium, such as a wired or wireless medium. In a preferred embodiment, the target USB device is a sensor for use on patients in a medical setting. More preferably, the target USB device is an X-ray sensor for use on patients in a dental office. However, any target USB device may be utilized in the present invention and the present invention should not be limited as described herein.

In the present invention, the target USB device 12 may be connected via USB connection to the peripheral connected device 14 via a USB host port 16 on the peripheral connected device 14. The peripheral connected device 14 may preferably be handheld and battery operated, and may further provide power via the USB connection to the target USB device 12 for functioning of the same and data transfer between the target USB device 12 and the peripheral connected device 14. The peripheral connected device 14 may include an antenna 18 for sending a wireless signal, preferably a Wi-Fi signal therethrough, although the present invention should not be limited to a Wi-Fi signal, as any useful wireless signal may be transmitted and received, as described herein, including WiGig, Bluetooth, infrared, high-capacity wireless signals, such as ultra-wideband (UWB) wireless signals and the like.

Alternatively, although the present invention is preferably a wireless system, it should be noted that the present invention may also be used with wired systems as well. Specifically, in place of a wireless communication protocol, the peripheral connected device may transfer data via a wired connection medium, such as a local area network via ethernet cables or any other like wired network.

A host computer 20 may have a USB port 22 to which a host connected device 24 is connected thereto via USB connection. The host computer may be any computing device capable of normally communicating with the target USB device 12, as described above, and further normally capable of transferring data between the target USB device 12 and the host computer 20. Examples include desktop computers, laptop computers, tablet computers, server computers, smart phones, and other like computing devices capable of receiving data through a USB port. The host connected device 24 may have an antenna 26 for receiving a wireless signal, preferably a Wi-Fi signal from the wireless transmitter 14.

In use, the target USB device 12 is plugged into the USB host port 16 of the host connected device 14. Preferably, target USB devices may be inserted and removed from peripheral connected devices when a user wants to use them, and thus may be plug-and-play, requiring no or minimal set-up. The target USB devices may be permanently plugged into respective peripheral connected devices or may be changed as needed.

As noted above, in a preferred embodiment, the target USB device 12 may be an X-ray sensor that may be used in a dental setting for imaging a patient's teeth, and may be connected to the peripheral connected device 14 as described above. Batteries within the peripheral connected device 14 may supply power to the X-ray sensors through the USB connection, although the peripheral connected device 14 may also be powered via direct hardline connection to a power source, such as a wall electrical receptacle.

The peripheral connected device 14 may pair with the host connected device 24. The host computer 20 may access and control the target USB device 12 connected to the peripheral connected device 14 through the wireless connection between the peripheral connected device 14 and the host connected device 24. Thus, if the target USB device 12 is an X-ray sensor, the X-ray sensor may be utilized to image a patient's teeth, and the data of the image may be sent through the peripheral connected device 14 to the host connected device 24 and thus to the host computer 20 attached thereto. Moreover, the host computer 20 may have control of aspects of the target USB device 12, which may be done by a user at the host computer 20. Thus, a dental hygienist, for example, may set an X-ray sensor in a patient's mouth, go to the host computer, and control the imaging of the X-ray sensor from the host computer.

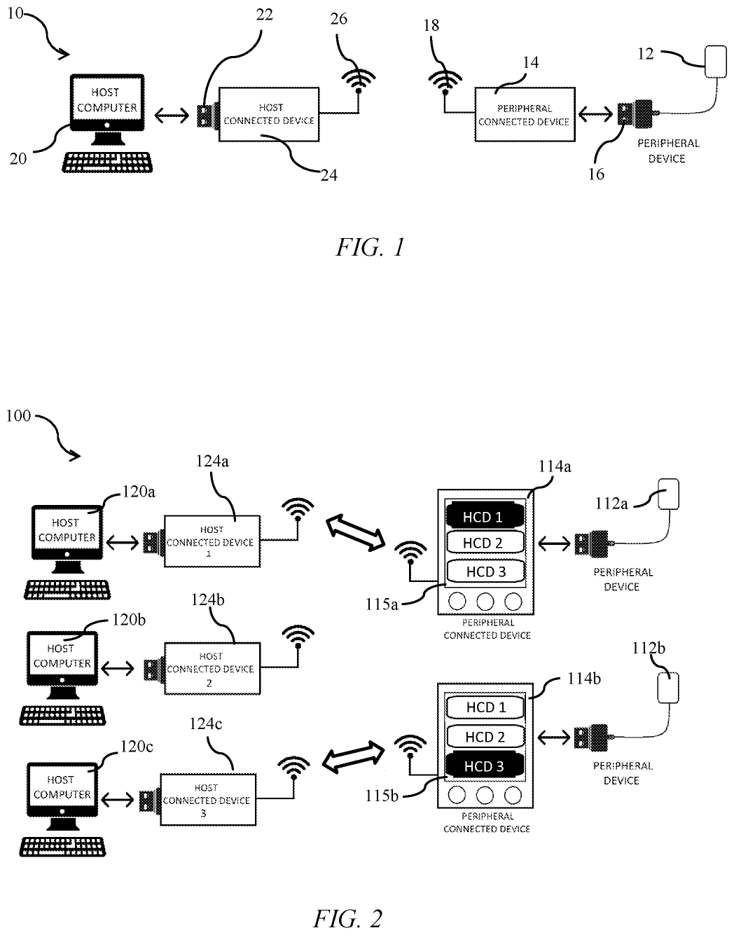

In an alternate exemplary embodiment of the present invention, a system 100 of the present invention, as illustrated in FIG. 2 may allow one of a plurality of peripheral connected devices to pair with one of a plurality of host connected devices. As shown a first target USB device 112a may be connected via USB connection to a first peripheral connected device 114a. A second target USB device 112b may be connected via USB connection to a second peripheral connected device 114b. Moreover, a first host computer 120a may be connected via USB connection to a first host connected device 124a; a second host computer 120b may be connected via USB connection to a second host connected device 124b; and a third host computer 120c may be connected via USB connection to a third host connected device 124c. Although FIG. 2 illustrates two peripheral connected devices (and, therefore, two target USB devices) and three host connected devices (and, therefore, three host computers), it should be noted that any number of peripheral connected devices and host connected devices (and, therefore, target USB devices and host computers, respectively) may be part of the system 100, and the present invention should not be limited as shown in FIG. 2 and described herein.

The first peripheral connected device 114a may connect to one of the three host connected devices 124a, 124b, 124c, as selected either by a user thereof at the first peripheral connected device 114a or otherwise automatically via the first peripheral device 114a. Specifically, the first peripheral connected device 114a may include a screen 115a showing a list of all of the host connected devices within range of the peripheral connected device 114a and capable of pairing therewith. Likewise, the second peripheral connected device 114b may include a screen 115b showing a list of the host connected devices within range of the second peripheral device 114b and capable of pairing therewith.

Specifically, the first and second peripheral connected devices 114a, 114b may be activated by a user by opting to power the same on, which may then cause the first and second peripheral connected devices 114a, 114b to scan for capable host connected devices within range and dynamically present each of the host connected devices within range on the screens 115a, 115b as capable of being selected by a user thereof. As illustrated in FIG. 2, first peripheral connected device 114a may show the first, second, and third host computers 120a, 120b, 120c, respectively, via the first, second, and third host connected devices 124a, 124b, 124c, and a user may select first host computer 120a via first host connected device 124a for pairing therewith. Likewise, as illustrated in FIG. 2, second peripheral device 114b may show the first, second, and third host computers 120a, 120b, 120c via the first, second and third host connected devices 124a, 124b, 124c, respectively, and a user may select third host computer 120c via third host connected device 124c for pairing therewith. Preferably, the order of host connected devices within range may be presented in a manner that indicates the relative strengths of a wireless signal between them, for example, if the connection medium is wireless. For example, the first, second, and third host connected devices 124a, 124b, 124c may be presented on first and second screens 115a, 115b in order of their strongest wireless signals. However, the order of wireless receivers within range may be presented in any manner, and the present invention should not be limited as described herein.

Therefore, once paired, a data transfer connection may be established between the selected host computer and the target USB device. Specifically, as illustrated in FIG. 2, the first USB target device 112a may trade data with the first host computer 120a through the first peripheral connected device 114a and the first host connected device 124a, and the second USB target device 112b may trade data with the third host computer 120c through the second peripheral connected device 114b and the third host connected device 124c. Of course, either of the first or second peripheral connected devices 114a, 114b may also have paired with the second host connected device 124b if the user had so desired.

Pairing may be accomplished simply by the user selecting the particular host connected device associated with the desired host computer to which the user wishes to pair with the peripheral connected device being utilized. Each of the host connected devices may be presented in a selected format on the first and second screens 115a, 115b. For example, the screens 115a, 115b may be touch screens and the user may select particular host connected devices simply by touching an icon or identification presented on the screens 115a, 115b, as desired. Alternatively, buttons next to the screens 115a, 115b may allow a user to select particular host connected devices by pushing the buttons.

Once the user is done using the particular target USB device 112a, 112b, the user may terminate the USB link via user-input, such as via a “disconnect” button on the peripheral connected devices 114a, 114b. Alternatively, if the respective peripheral connected device and/or host connected device detect inactivity for a pre-defined timeout period, the peripheral connected device and/or host connected device may automatically terminate the USB connection and preferably power down to protect battery life.

In an alternate embodiment of the present invention, the screens 115a, 115b on the peripheral connected devices 114a, 114b, respectively, as described herein, may also be used to show an image or other data produced by the target USB device. For example, if the target USB device is an X-ray sensor, then the screen may show the X-ray image produced by the X-ray sensor. Thus, a user of the target USB sensor may be able to see the data, such as the X-ray image, immediately on the screen of the peripheral connected device while, at the same time, the image is sent to the selected host computer. The peripheral connected devices 114a, 114b may include image processing capabilities to aid in displaying the image from the target USB device.

In addition, the various components described herein may be controlled by other means besides selecting through buttons, whether real or virtually displayed on the screens 115a, 115b as described herein. Specifically, the various components described herein may be activated and/or controlled via motion sensors, voice recognition capabilities, such as voice activated commands, or other like alternative control mechanisms.

In an alternate embodiment of the present invention, each of the peripheral connected devices, which may be connected to peripheral devices as described herein, may have a storage medium, such as a solid-state memory, for example, for holding the data transferred thereto from the peripheral device. Thus, in case a host computer is unavailable, or a communication session is interrupted, the storage medium may hold the data from the peripheral device to transfer to a host computer at a later time, either via the data transfer systems and methods described herein, or via another method. For example, the storage medium may be a removable solid state memory drive that may be removed from the peripheral connected device and physically transported to a host computer.

Likewise, the host connected devices may further have a storage medium therein for holding the data transferred thereto from the peripheral connected devices so that the data transferred thereto may be preserved in case of disconnection from the host computer before the data transfer thereto is complete.

In another alternate embodiment of the present invention, data that is transferred from the peripheral connected devices to respective host connected devices may be filtered, processed and otherwise manipulated at the peripheral connected devices prior to transferring the data to a host computer. For example, the data collected from a peripheral device at a peripheral connected device may be presented to a user, such as, for example, through the screen thereof, and a user may filter the data by selecting a portion of the data for transfer. Alternatively, the data may be automatically filtered and/or processed via a processor within the peripheral connected device to manipulate the data, such as via pre-programmed algorithms and/or artificial intelligence. Further, the data may both be processed and manipulated and presented to a user at the peripheral connected device for filtering thereof.

In an exemplary embodiment, data may include imagery from an imaging peripheral device, such as an x-ray apparatus or the like. Several images may be captured by the peripheral device, and the peripheral connected device may utilize algorithms or otherwise utilize artificial intelligence to filter the images to a sub-set of images. In addition, the peripheral connected device may further process the images to make more readable, such as by increasing contrast levels, by coloring images, or in any other manner apparently to one of ordinary skill in the art. The processed and/or filtered images may then be transferred to the respective host computer via the systems and methods described herein, and the unused data may either be stored for later use or discarded.

### EXAMPLES

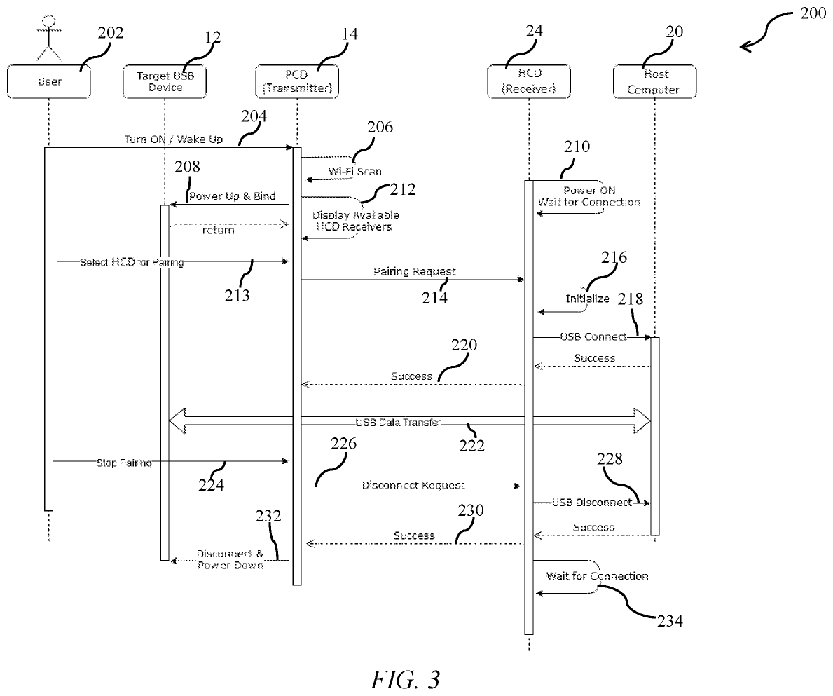

In a first exemplary methodology, FIG. 3 illustrates a flowchart 200 showing how a user 202 utilizes target USB device 12, as illustrated in FIG. 1 and described herein, to wirelessly connect to host computer 20 via wireless connection between peripheral connected device 14 and host connected device 24. Specifically, the flowchart 200 assumes that peripheral connected device 14 is already connected to target USB device 12 and host computer 20 is already connected to host connected device 24.

In a first step 204, the user 202 turns on and/or wakes up peripheral connected device 14, at which time the peripheral connected device 14 performs a wireless scan via step 206. At the same time, or nearly simultaneously, the peripheral connected device 14 may power up and bind target USB device 12, establishing a USB connection therebetween via step 208. Also, the host connected device 24 may be powered on and await connection via step 210. Upon completing the scan of nearby host connected devices within range, the peripheral connected device 14 may display available host connected devices via step 212.

The user 202 may select a desired host connected device for pairing via step 213, at which time a pairing request may be sent from the peripheral connected device 14 to the host connected device 24 via step 214. The host connected device 24 may initialize via step 216 and ensure a USB connection between the host connected device 24 and the host computer 20 via step 218. If successful, then the host connected device 24 will confirm the pairing request with the wireless peripheral connected device 14 and the pairing connection will be established via step 220. Data transfer between the target USB device 12 and the host computer 20 may subsequently occur via step 222.

When finished, or otherwise when desired, the user may elect to stop pairing via step 224 by selecting a “disconnect” option on the peripheral connected device 14. A disconnect request may then be sent from peripheral connected device 14 to host connected device 24 via step 226, at which time the host connected device 24 may disconnect the USB connection between the host connected device 24 and the host computer 20 via step 228. Once disconnected, the host connected device 24 may confirm the disconnection with the peripheral connected device 14, thereby severing the connection therebetween via step 230. Once disconnected, the target USB device 14 may power down to save battery via step 232. The host connected device 24 may await subsequent connection to peripheral connected device 14 via step 234.

In a preferred embodiment of the present invention, only one peripheral connected device may be paired with only one host connected device until the user decides to disconnect or if the peripheral connected device and host connected device opt to disconnect due to inactivity. Thus, a second request to pair a peripheral connected device with an already-paired host connected device is preferably rejected and fails. This preferred policy is to ensure that an existing USB link between a peripheral connected device and host connected device does not get disturbed while in use.

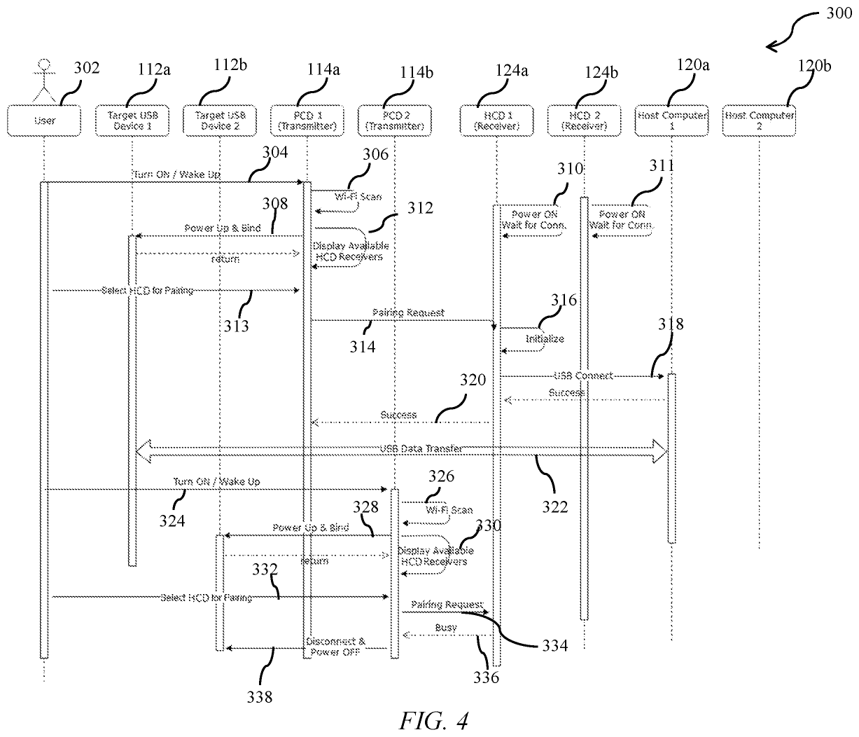

In a second exemplary methodology, FIG. 4 illustrates a flow chart 300 demonstrating how a second connection to an already-connected host connected device may be refused. Specifically, flowchart 300 shows how a user 302 utilizes first target USB device 112a, as illustrated in FIG. 2 and described herein, to wirelessly connect to first host computer 120a via wireless connection between first peripheral connected device 114a and first host connected device 124a. Specifically, the flowchart 300 assumes that first peripheral connected device 114a is already physically connected to first target USB device 112a and first host computer 120a is already physically connected to first host connected device 124a. Likewise, flowchart 300 assumes that second peripheral connected device 114b is already physically connected to second target USB device 112b and second host computer 120b is already physically connected to second host connected device 124b.

In a first step 304, the user 302 turns on and/or wakes up first peripheral connected device 114a, at which time the first peripheral connected device 114a performs a wireless scan via step 306. At the same time, or nearly simultaneously, the first peripheral connected device 114a may power up and bind first target USB device 112a, establishing a USB connection therebetween via step 308. Also, the first host connected device 124a may be powered on and await connection via step 310 and second host connected device 124b may be powered on and await connection via step 311. Upon completing the scan of nearby host connected devices within range, the first peripheral connected devices 114a may display available host connected devices via step 312.

The user 302 may select first host connected device 124a for pairing via step 313, at which time a pairing request may be sent from the first peripheral connected device 114a to the first host connected device 124a via step 314. The first host connected device 124a may initialize via step 316 and ensure a USB connection between the first host connected device 124a and the first host computer 120a via step 318. If successful, then the first host connected device 124a may confirm the pairing request with the first peripheral connected device 114a and the pairing connection may be established via step 320. Data transfer between the first target USB device 112a and the first host computer 120a may subsequently occur via step 322.

Subsequently, in step 324 the user 302 may turn on and/or wake up second peripheral connected device 114b, at which time the second peripheral connected device 114b may perform a wireless scan via step 326. At the same time, or nearly simultaneously, the second peripheral connected device 114b may power up and bind second target USB device 112b, establishing a USB connection therebetween via step 328. Upon completing the scan of nearby host connected devices within range, the second peripheral connected device 114b may display available host connected devices via step 330.

The user 302, or another user thereof, may select first host connected device 124a for pairing with the second peripheral connected device 124b via step 332, at which time a pairing request may be sent from the second peripheral connected device 114b to the first host connected device 124a via step 334. However, because first host connected device 124a may already be paired with first peripheral connected device 114a, first host connected device 124a may indicate that it is busy or otherwise unavailable for pairing via step 336, thus effectively rejecting the pairing request from second peripheral connected device 114b. Without attempting to connect to an alternate host connected device, second peripheral connected device 114b may disconnect from second target USB device 112b and power down via step 338, thereby saving battery life.

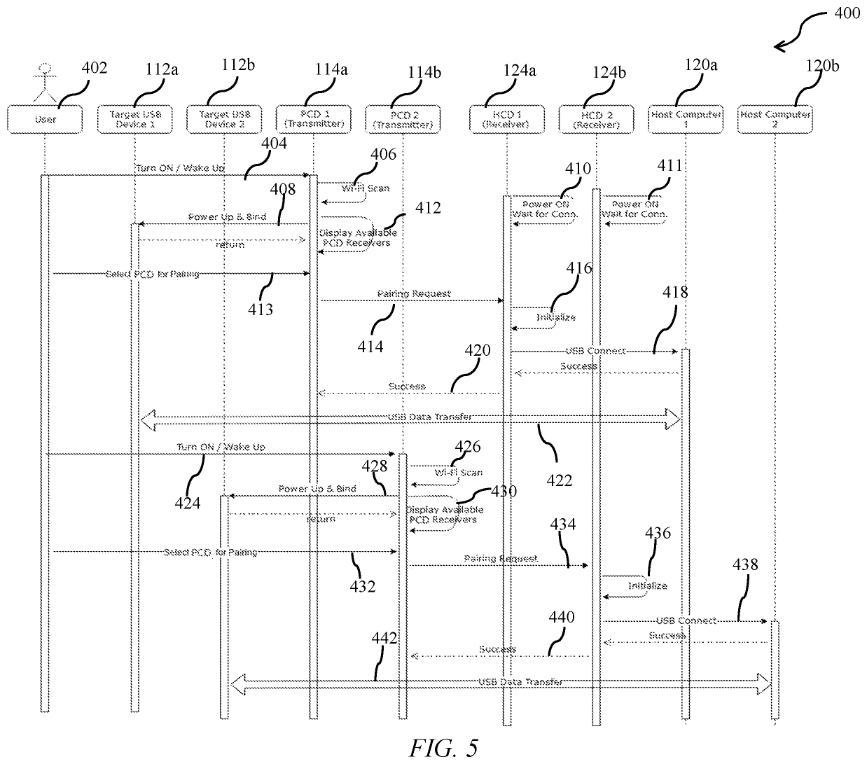

In a third exemplary methodology, FIG. 5 illustrates a flow chart 400 demonstrating how two concurrent USB data transfers can coexist. Specifically, flowchart 400 shows how a user 402 utilizes first target USB device 112a, as illustrated in FIG. 2 and described herein, to wirelessly connect to first host computer 120a via wireless connection between first peripheral connected device 114a and first host connected device 124a. Likewise, flowchart shows how a user 402 (or another user) utilizes second target USB device 112b to wirelessly connect to second host computer 120b via wireless connection between second peripheral connected device 114b and second host connected device 124b. Specifically, the flowchart 400 assumes that first peripheral connected device 114a is already physically connected to first target USB device 112a and first host computer 120a is already physically connected to first host connected device 124a. Likewise, flowchart 400 assumes that second peripheral connected device 114b is already physically connected to second target USB device 112b and second host computer 120b is already physically connected to second host connected device 124b.

In a first step 404, the user 402 turns on and/or wakes up first peripheral connected device 114a, at which time the first peripheral connected device 114a performs a wireless scan via step 406. At the same time, or nearly simultaneously, the first peripheral connected device 114a may power up and bind first target USB device 112a, establishing a USB connection therebetween via step 408. Also, the first host connected device 124a may be powered on and await connection via step 410 and second host connected device 124b may be powered on and await connection via step 411. Upon completing the scan of nearby host connected devices within range, the first wireless transmitter 114a may display available host connected devices via step 412.

The user 402 may select first host connected device 124a for pairing via step 413, at which time a pairing request may be sent from the first peripheral connected device 114a to the first host connected device 124a via step 414. The first host connected device 124a may initialize via step 416 and ensure a USB connection between the first host connected device 124a and the first host computer 120a via step 418. If successful, then the first host connected device 124a may confirm the pairing request with the first peripheral connected device 114a and the pairing connection may be established via step 420. Data transfer between the first target USB device 112a and the first host computer 120a may subsequently occur via step 422.

Subsequently, in step 424 the user 402, or another user, may turn on and/or wake up second peripheral connected device 114b, at which time the second peripheral connected device 114b may perform a wireless scan via step 426. At the same time, or nearly simultaneously, the second peripheral connected device 114b may power up and bind second target USB device 112b, establishing a USB connection therebetween via step 428. Upon completing the scan of nearby host connected devices within range, the second peripheral connected device 114b may display available host connected devices via step 430.

The user 402, or another user thereof, may select second host connected device 124b for pairing with the second peripheral connected device 114b via step 432, at which time a pairing request may be sent from the second peripheral connected device 114b to the second host connected device 124b via step 434. The second host connected device 124b may initialize via step 436 and ensure a USB connection between the second host connected device 124b and the second host computer 120b via step 438. If successful, then the second host connected device 124b may confirm the pairing request with the second peripheral connected device 114b and the pairing connection may be established via step 440. Data transfer between the second target USB device 112b and the second host computer 120b may subsequently occur via step 432.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

We claim:

1. A system for connecting a peripheral device to one of a plurality of host computers to transfer data therebetween comprising:
a first peripheral device connected to a first peripheral connected device;
a first host computer connected to a first host connected device;
wherein the first peripheral connected device is configured to scan for available host connected devices and identify on the first peripheral connected device the available host connected devices found in the scan, and
wherein the first host connected device is selectable at the first peripheral connected device, wherein selecting the first host connected device causes the first peripheral connected device to pair with the first host connected device establishing a first connection allowing data to transfer between the first peripheral device and the first host computer.

2. The system of claim 1 wherein the first peripheral device is connected to the first peripheral connected device via a first USB connection, the first host computer is connected to the first host connected device via a second USB connection.

3. The system of claim 1 wherein the first peripheral connected device and the first host connected device transfer data between the first peripheral device and the first host computer via a wired or wireless connection.

4. The system of claim 1 wherein the first peripheral connected device and the first host connected device transfer data between the first peripheral device and the first host computer via a wireless connection.

5. The system of claim 1 further comprising:
a second host computer connected to a second host connected device,
wherein selecting the second host connected device causes the first peripheral connected device to pair with the second host connected device establishing a second connection allowing the data to transfer between the first peripheral device and the second host computer.

6. The system of claim 5 further comprising:
a second peripheral device connected to a second peripheral connected device,
wherein the first host connected device and the second host connected device are selectable at the second peripheral connected device.

7. The system of claim 1 further comprising:
a second peripheral device connected to a second peripheral connected device,
wherein the first host connected device is selectable at the second peripheral connected device.

8. The system of claim 1 wherein the first peripheral connected device comprises a screen, wherein the available host connected devices are displayed on the screen.

9. The system of claim 1 wherein the first peripheral connected device comprises a screen, wherein data generated by the first peripheral device is displayed on the screen.

10. The system of claim 1 wherein the first peripheral connected device comprises a storage medium, wherein data generated by the first peripheral device is stored in the storage medium of the first peripheral connected device.

11. A method for connecting at least one peripheral device to one of a plurality of host computers to transfer data therebetween comprising:
providing a first peripheral device connected to a first peripheral connected device;
providing at least one host computer connected to a first host connected device;
scanning, at the first data transmitter, for available host connected devices;
identifying on the first peripheral connected device the available host connected devices found in the scan, wherein the first host connected device is selectable at the first peripheral connected device;
selecting the first host connected device at the first peripheral connected device, wherein selecting the first host connected device causes the first peripheral connected device to pair with the first host connected device establishing a first connection allowing first data to transfer between the first peripheral device and the first host computer; and
transferring the first data between the first peripheral connected device and the first host connected device.

12. The method of claim 11 wherein the first peripheral connected device and the first host connected device transfer the first data between the first peripheral device and the first host computer via a wired or a wireless connection.

13. The method of claim 11 wherein the first peripheral connected device and the first host connected device transfer the data between the first peripheral device and the first host computer via a wireless connection.

14. The method of claim 11 further comprising the steps of:
providing a second host computer connected to a second host connected device;
selecting the second host connected device at the first peripheral connected device, wherein selecting the second host connected device causes the first peripheral connected device to pair with the second host connected device establishing a second connection allowing second data to transfer between the first peripheral device and the second host computer; and
transferring the second data between the first peripheral connected device and the second host connected device.

15. The method of claim 11 further comprising the steps of:
providing a screen on the first peripheral connected device; and
displaying the first data from the first peripheral device on the first screen.

16. The method of claim 11 further comprising the steps of:
providing a screen on the first peripheral connected device; and
displaying the available data receivers on the screen.

17. The method of claim 11 further comprising the step of:
providing a second peripheral device connected to a second peripheral connected device, wherein the first host connected device is selectable at the second peripheral connected device.

18. The method of claim 17 further comprising the steps of:
selecting the first host connected device at the second peripheral connected device; and
receiving a message at the second peripheral connected device indicating that the first host connected device is unavailable to connect to the second peripheral connected device.

19. The method of claim 17 further comprising the steps of:
providing a second host computer connected to a second host connected device;
selecting the second host connected device at the second peripheral connected device, wherein selecting the second host connected device causes the second data peripheral connected device to pair with the second host connected device establishing a second connection allowing second data to transfer between the second peripheral device and the second host computer; and
transferring the second data between the second peripheral connected device and the second host connected device.

20. The method of claim 17 further comprising the steps of:
providing a first screen on the first peripheral connected device;
displaying the available data receivers on the first screen;
providing a second screen on the second peripheral connected device; and
displaying the available data receivers on the second screen.

21. The method of claim 20 wherein the step of selecting the first host connected device at the first peripheral connected device further comprises:
selecting the first host connected device on the first screen of the first peripheral connected device, and further comprising the steps of:
selecting the second host connected device on the second screen of the second peripheral connected device; and
transferring the second data between the second peripheral connected device and the second host connected device.

22. The method of claim 11 further comprising the steps of:
processing the first data at the first peripheral connected device prior to transferring the first data from the first peripheral connected device to the first host connected device.

23. A method for connecting at least one peripheral device to one of a plurality of host computers to transfer data therebetween comprising:
providing a first peripheral device connected to a first peripheral connected device, wherein the first peripheral connected device comprises a storage medium;
providing at least one host computer connected to a first host connected device;
scanning, at the first data transmitter, for available host connected devices; and
storing first data in the storage medium of the first peripheral connected device.

24. The method of claim 23 further comprising the steps of:
selecting the first host connected device at the first peripheral connected device;
pairing the first peripheral connected device with the first host connected device; and
sending the first data from the storage medium of the first peripheral connected device to the first host connected device.
